(19) United States
(12) Patent Application Publication
(10) Pub. No.: US 2012/0218745 A1
(43) Pub. Date: Aug. 30, 2012

(54) LED LAMP

(75) Inventors: TING DONG, Shenzhen City (CN); YONG-YOU MING, Shenzhen City (CN); WEN-HSIANG LU, Tu-Cheng (TW); CHIH-HUNG MOU, Tu-Cheng (TW); XUE-ZHENG ZOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/241,267

(22) Filed: Sep. 23, 2011

(30) Foreign Application Priority Data
Feb. 28, 2011 (CN) 201110047802.4

(51) Int. Cl. F21V 21/00

(52) U.S. Cl. 362/217.14

(57) ABSTRACT

An LED lamp includes a lamp body, a pair of holders received in the lamp body, a circuit board with a number of LEDs, and a pair of connectors. The circuit board is received in the lamp body but spaced from insides of the lamp body. The opposite ends of the circuit board are fixed to the holders correspondingly. The connectors are fixed to the holders and abut against opposite ends of the lamp body.

### BACKGROUND

1. Technical Field

The present disclosure relates to LED lamps, especially to an LED lamp having simplified structure.

2. Description of Related Art

Compared to other kinds of light sources, light emitting diodes (LEDs) have many advantages, such as high luminous efficiency, low power consumption, and long service life. LED lamps are widely used in many applications. Generally, the LED lamp is complicated in structure. Therefore, an LED lamp having a simplified structure is needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an LED lamp according to an exemplary embodiment.

FIG. 2 is an exploded view of the LED lamp of FIG. 1.

FIG. 3 is an isometric view of a connector of the LED lamp of FIG. 1.

FIG. 4 is an isometric view of a conductive member of the LED lamp of FIG. 1.

FIG. 5 is a cross-sectional view of the LED lamp of FIG. 1.

### DETAILED DESCRIPTION

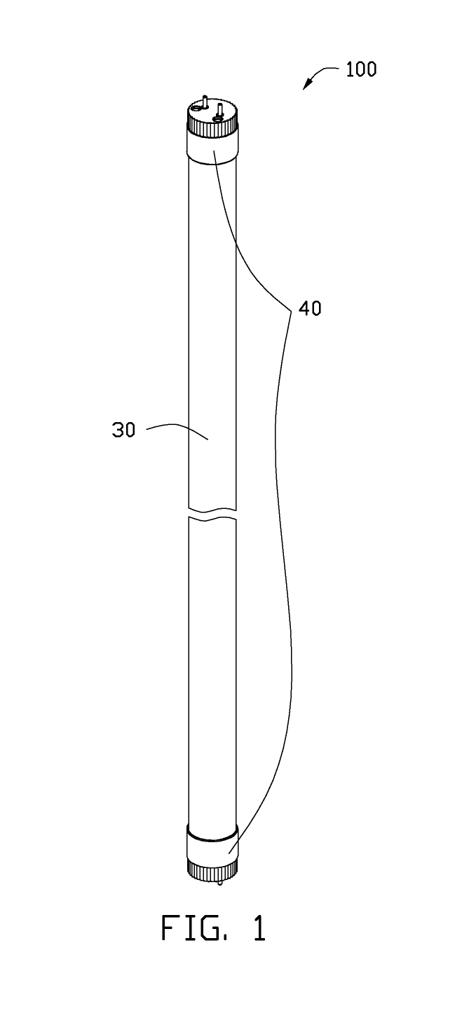

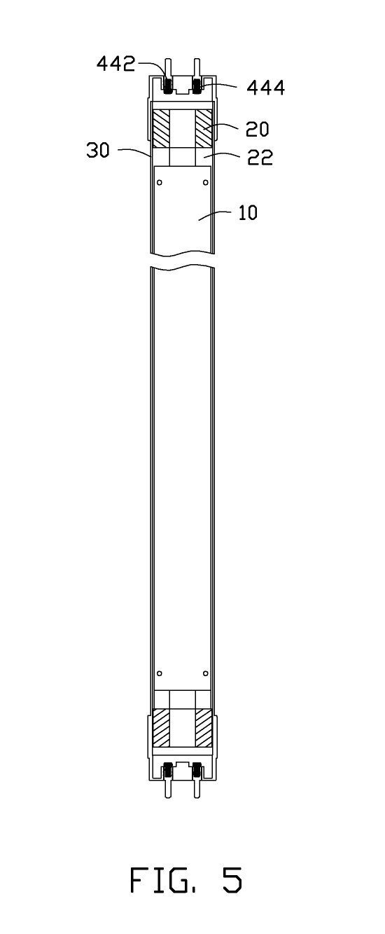

Referring to FIGS. 1, 2 and 5, an LED lamp 100 includes a circuit board 10, a pair of holders 20, a lamp body 30, and a pair of connectors 40.

The lamp body 30 is a hollow cylinder and is made of glass. The lamp body 30 can receive the circuit board 10 and the holder 20 therein.

The circuit board 10 has a substantially elongated shaped. The circuit board 10 is received in but spaced from insides of the lamp body 30. The circuit board 10 includes a number of LEDs 11 mounted thereon. The circuit board 10 defines four through holes 14 that are disposed at four corners of the circuit board 10.

The holders 20 are received in the lamp body 30. Each holder 20 includes a pair of lateral walls 21 opposite to each other. Each lateral wall 21 defines a threaded hole 211 along its longitudinal direction. A support tab 22 protrudes from one end of each lateral wall 21. Each support tab 22 includes a protrusion 23 extending through the through holes 14, and is partly melted, thereby fixing the holders 20 to opposite ends of the circuit board 10.

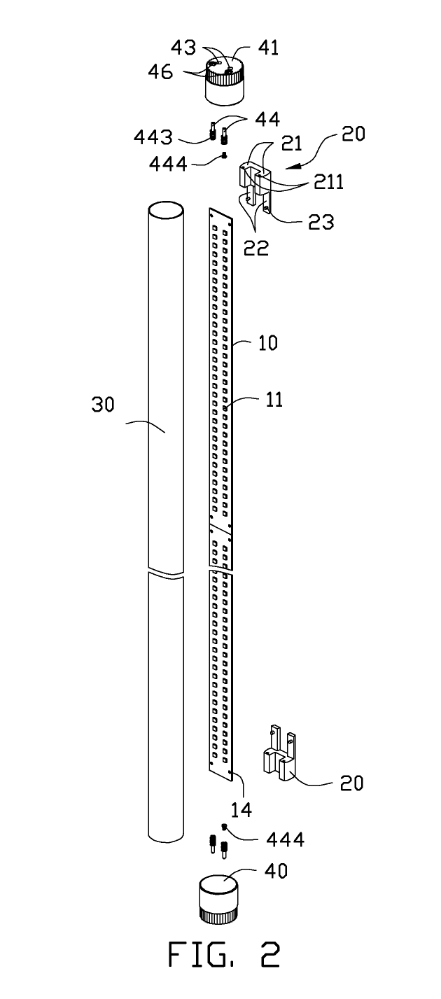

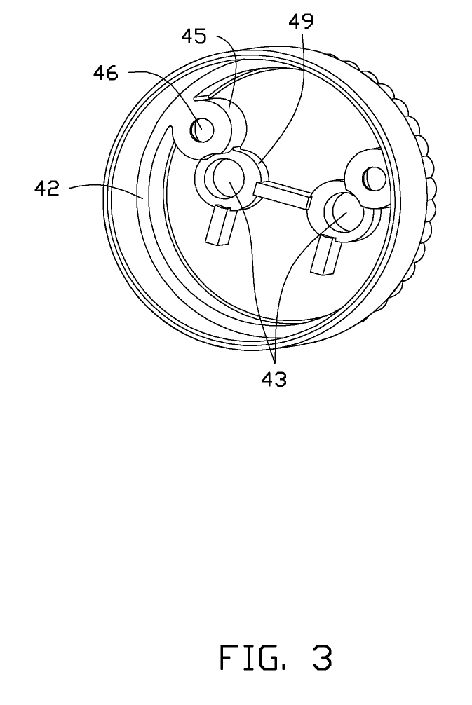

Referring to FIGS. 2 and 3, the pair of connectors 40 are respectively disposed at opposite ends of the lamp body 30. The connectors 40 are substantially hollow cylinders. Each connector 40 includes a ring 42 protruded from its inner lateral surface. The rings 42 abut against opposite ends of the lamp body 30.

Each connector 40 further includes a closed end 41 and an open end opposite to the closed end 41. In the exemplary embodiment, each closed end 41 further includes a pair of sleeves 45 protruded from its inner end surface. Each sleeve 45 defines a through hole 46. A pair of threaded bolts (not shown) can extend through the through holes 46 and be screwed into the threaded holes 211, fixing the connectors 40 to the holder 20. The closed end 41 further includes a pair of sleeves 49 protruding from its inner end surface. Each sleeve 49 defines a through hole 43.

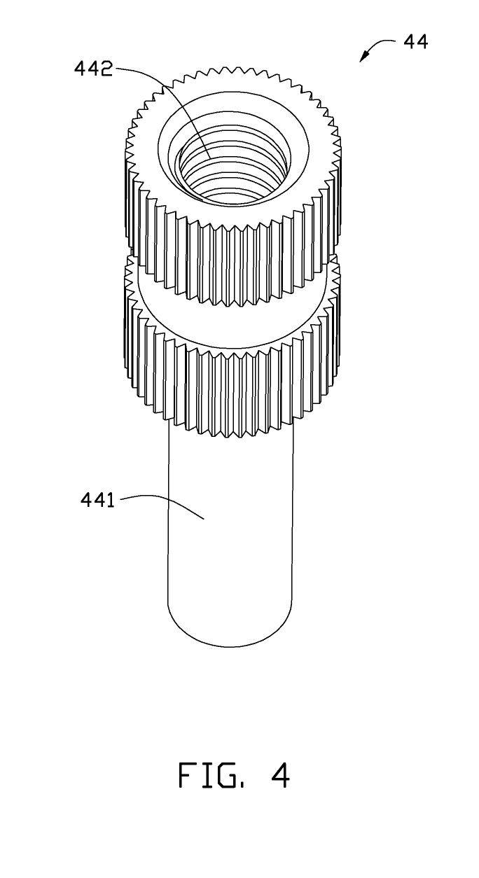

Referring to FIGS. 2, 4 and 5, each connector 40 further includes a pair of conductive members 44. Each conductive member 44 is substantially cylindrical. Each conductive member 44 includes a head portion 443 fixed in a corresponding one of the sleeves 49. Each conductive member 44 further includes a conductive pin 441 extending from the head portion 443, passing through the through hole 43 and protruding from the closed end 41. Therefore, the conductive members 44 can be electrically connected to a power source via the conductive pins 441. Each conductive member 44 defines a threaded hole 442 in its head portion 443. A plurality of screws 444 are screwed into the threaded holes 442. The screws 444 are used to fix wires (not shown) electrically connected to the circuit board 10, thereby allowing the circuit board 10 to be connected to the power source.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED lamp comprising:
a lamp body;
a pair of holders received in the lamp body but spaced from insides of the lamp body;
a circuit board comprising a plurality of LEDs and received in the lamp body, and opposite ends of the circuit board being fixed to the holders correspondingly; and
a pair of connectors fixed to the holders and abutting against opposite ends of the lamp body.

2. The LED lamp of claim 1, wherein the circuit board defines a plurality of through holes, and each holder comprises at least one protrusion extending through a corresponding through hole and partly melted to fix the holders to the circuit board.

3. The LED lamp of claim 1, wherein each holder defines at least one threaded hole, each connector defines at least one through hole, at least two threaded bolts extend through the at least two through holes and are screwed into the at least two threaded holes, to fix the pair of connectors to the pair of holders.

4. The LED lamp of claim 1, wherein each connector is substantially a hollow cylinder, and comprises a ring protruded from an inner lateral surface thereof, and the pair of rings abuts against the opposite ends of the lamp body.

5. The LED lamp of claim 1, wherein each connector comprises a pair of conductive members and a closed end, the closed end defines a pair of through hole, each conductive member comprises a conductive pin, the conductive pin passing through the through hole and protrudes from the closed end.
